(19) United States
(12) Patent Application Publication
(10) Pub. No.: US 2010/0332880 A1
(43) Pub. Date: Dec. 30, 2010

(54) Mobile Electronic Device

(75) Inventor: Akira Koyama, Kanagawa (JP)

Correspondence Address: PROCOPIO, CORY, HARGREAVES & SAVITCH LLP, 525 B STREET, SUITE 2200, SAN DIEGO, CA, 92101, US

(73) Assignee: KYOCERA CORPORATION, Kyoto (JP)

(21) Appl. No.: 12/865,516

(22) PCT Filed: Jan. 30, 2009
(86) PCT No.: PCT/JP2009/051661

§ 371 Date: Jul. 30, 2010

(30) Foreign Application Priority Data
Jan. 30, 2008 (JP) 2008-019983

(51) Int. Cl. G06F 1/32; G01N 27/416

(52) U.S. Cl. 713/323; 324/426

(57) ABSTRACT

An object of the invention is, in a mobile electronic device having a sleep mode for power saving, to make it easy to measure a current in a sleep period without requiring a measurement device with high-resolution precision. On the basis of a reference capacity table and a sleep period current value measured by a measurement device connected from the outside which are stored in a storage unit (16) in advance, a control unit (17) calculates a remaining battery amount by summing a current value actually measured at a non-sleep time and an integrating value of a sleep time and a sleep period current value, and subtracting the sum value from a reference capacity value stored in the reference capacity table (160).

### TECHNICAL FIELD

The present invention relates to a mobile electronic device displaying a remaining battery amount on a display unit, and more particularly, to a mobile electronic device suitably used as a mobile phone.

### BACKGROUND ART

Generally, in mobile electronic devices such as mobile phones, a remaining battery amount is displayed on a display unit such as a liquid crystal display device (LCD) or an organic light emitted diode (OLED) to inform a user of the remaining battery amount.

For this reason, it is necessary to measure a current in a mobile phone. Conventionally, a current monitoring resistor is connected in series between a battery and a mobile phone main part, and a drop in voltage between both ends thereof is monitored and converted into a current value.

Regarding techniques of monitoring the remaining battery amount, a plurality of patent applications have been filed. For example, a detecting method with high precision in two kinds of states of a large current time and a small current time has been known (see Patent Document 1). Specifically, monitoring is performed based on a current in a part where voltage change is relatively gentle and based on a voltage in a part where voltage change is sudden, thereby measuring a remaining battery amount.

### [Patent Document 1] WO1998/102889

### DISCLOSURE OF THE INVENTION

In a standby state, the mobile phone device is activated by flowing a relatively large current in a constant time period and becomes a sleep state of flowing a minute current in other timing. That is, the mobile phone device can perform measurement on voltage or current only during the device being active, and the measurement is difficult in a sleep period. If the current measurement is forcibly performed in the sleep period, since the device is required to be activated, power saving operation can not be performed.

An object of the present invention is, in a mobile electronic device having a sleep mode for power saving, to make it easy to measure a current in a sleep period without requiring a measurement device with high-resolution precision.

### Problem to be Solved by the Invention

In order to solve the above-described problem, a mobile electronic device according to the present invention includes: a battery that is chargeable and dischargeable; a current measuring unit that measures a current output from the battery; a control unit that performs an operation control according to either a sleep mode in which an operation restriction is performed for power saving or an active mode in which the operation restriction is not performed; and a storage unit that stores a current value consumed in a sleep state where the operation control is performed in the sleep mode, as a sleep current value, wherein the control unit acquires a present remaining battery amount by summing a current consumption amount, which is a current amount consumed in an active state where the operation control is performed in the active mode and calculated on the basis of a current value measured by the current measuring unit, and an integrating value of an operation time in the sleep state and the sleep current value, and subtracting the sum value from a predetermined reference capacity value of the battery.

In the mobile electronic device according to the present invention, the storage unit may store a table in which a capacity value of the battery is associated with each current consumption amount, in advance, and the control unit may use, as the predetermined reference capacity value, a capacity value which is specified by referring to the table with a sum value at a previous calculating time as the current consumption amount.

The mobile electronic device according to the present invention may further include a display unit that performs display regarding the remaining battery amount, and the control unit may compare the acquired remaining battery amount with a plurality of predetermined stepwise threshold values each time when the remaining battery amount is calculated, and update the display regarding the remaining battery amount when the remaining battery amount exceeds each of the plurality of threshold values.

In the mobile electronic device according to the present invention, the control unit may change the predetermined reference capacity value stored in the storage unit according to a temperature coefficient or a deterioration coefficient of the battery.

The mobile electronic device according to the present invention may further include a wireless communication unit, and the control unit may perform operation control of the sleep mode at least at an intermittent reception timing of the wireless communication unit.

In the mobile electronic device according to the present invention, the control unit may calculate an average current value from the sum of the current value measured by the current measuring unit in the active mode and the integrating value of the operation time in the sleep state and the sleep current value stored in the storage unit, and display the average current value on the display unit.

### EFFECT OF THE INVENTION

According to the present invention, in the mobile electronic device having a sleep mode for power saving, a current can be easily measured in a sleep period without requiring a measurement device with high-resolution precision.

### BRIEF DESCRIPTION OF DRAWINGS

FIG. 1 is diagram illustrating an example of an exterior configuration of a mobile electronic device according to an embodiment of the invention.

FIG. 2 is a block diagram illustrating an interior configuration of an electrical system of the mobile electronic device according to the embodiment of the invention.

FIG. 3 is a block diagram illustrating an example of an interior configuration of a power control unit of the mobile electronic device according to the embodiment of the invention.

FIG. 4 is a diagram illustrating an example of a connection configuration with a high-precision ammeter used in a producing process of the mobile electronic device according to the embodiment of the invention. FIG. 5 is a diagram illustrating an example of a data structure of a storage unit (reference capacity table 160) of the mobile electronic device according to the embodiment of the invention.

FIG. 6 is a flowchart illustrating a basic operation of the mobile electronic device according to the embodiment of the invention.

FIG. 7 is a current waveform diagram in a standby status to explain an operation of calculating a current consumption amount in the mobile electronic device according to the embodiment of the invention.

FIG. 8 is a graph illustrating temperature characteristics and deterioration characteristics of a battery used in the mobile electronic device according to the embodiment of the invention.

### EXPLANATION OF REFERENCE

10: power control unit, 11: wireless communication unit, 12: operation unit, 13: audio input/output unit, 14: display unit, 15: imaging unit, 16: storage unit, 17: control unit, 18: system bus, 20: mobile phone main part, 30: battery, 31: power supply unit, 32: current amplifier, 41: stabilized power supply, 42: ammeter, 43: control PC, 44: input/output connector, 100: mobile phone, 160: reference capacity table, 161: temperature characteristic data, and 162: deterioration characteristic data

### BEST MODE FOR CARRYING OUT THE INVENTION

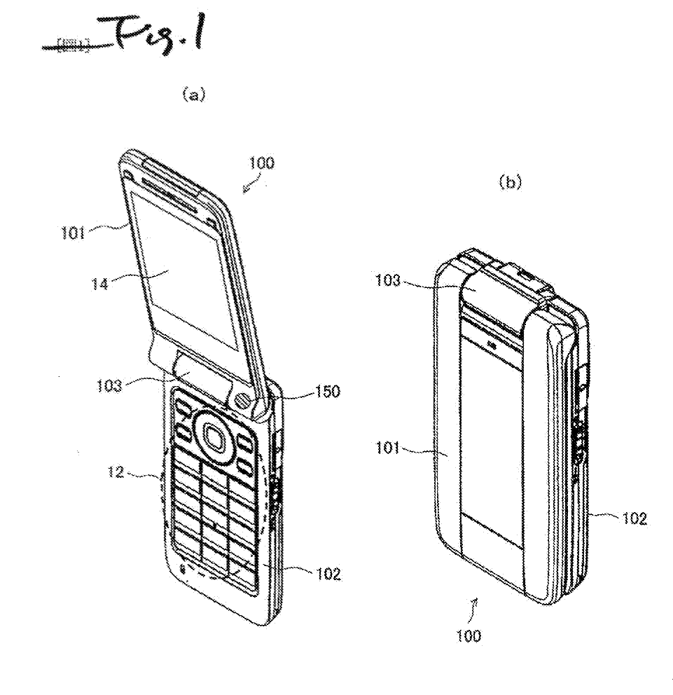

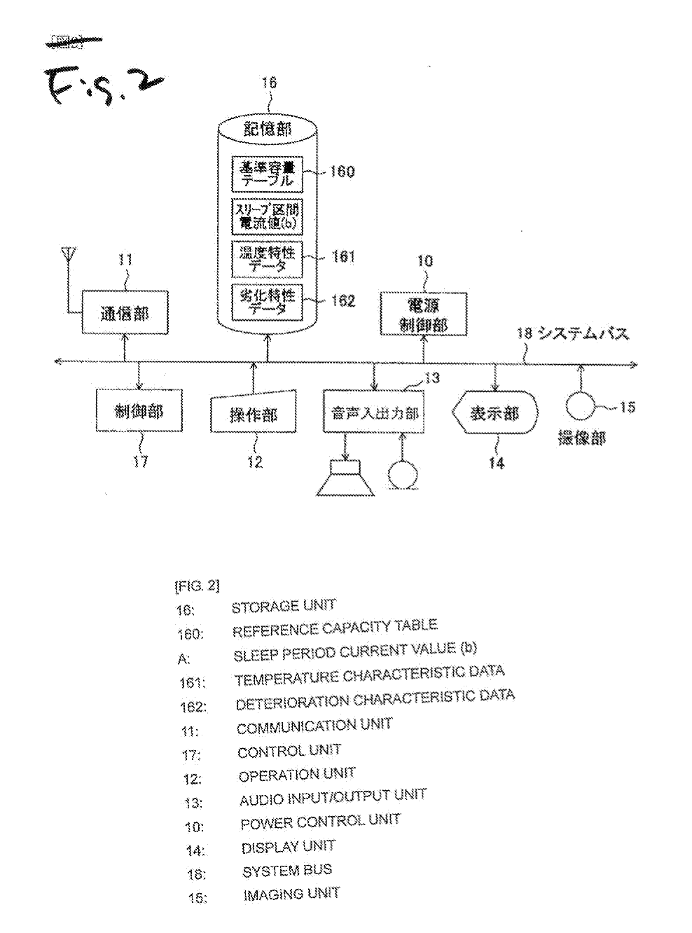

FIG. 1 is a diagram illustrating an example of an exterior configuration of a mobile electronic device according to an embodiment of the invention. Herein, as the mobile electronic device, a mobile phone 100 of a foldable type is assumed.

As shown in FIG. 1, the mobile phone 100 has an upper case 101, a lower case 102, and a hinge portion 103.

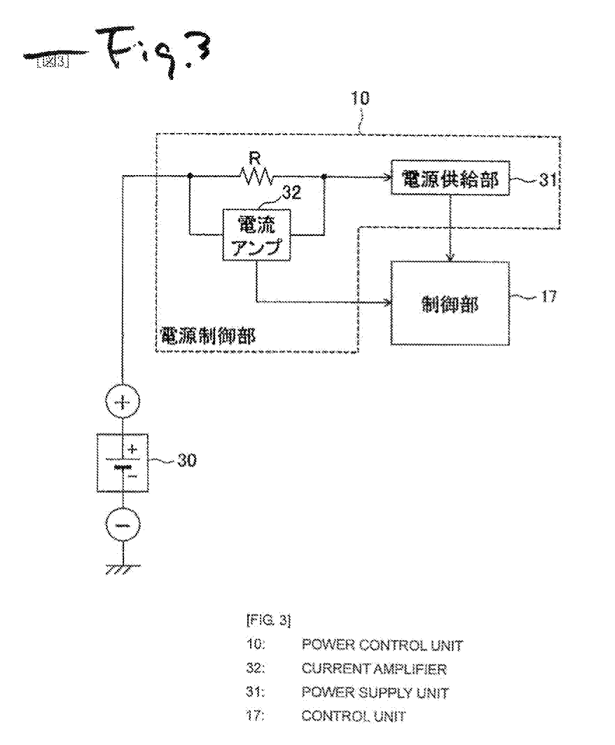

FIG. 1(a) is a diagram illustrating a state where the mobile phone 100 is open (opened state), and FIG. 2(b) is a diagram illustrating a state where the mobile phone 100 is folded (closed state).

As shown in FIG. 1(a), a display unit 14 is provided on a face of the upper case 101 which is not exposed to the outside in the closed state of the mobile phone 100 shown in FIG. 1(b).

As shown in FIG. 1(a), an operation unit 12 is provided on a face of the lower case 102 which is not exposed to the outside in the closed state of the mobile phone 100 shown in FIG. 1(b).

The hinge portion 103 has a hinge configuration with a rotation shaft which allows the upper case 101 and the lower case 102 to be opened and closed, so that the mobile phone 100 is movable between the opened state shown in FIG. 1(a) and the closed state shown in FIG. 1(b). The opened state and the closed state of the mobile phone 100 are monitored by a control unit 17 to be described later, and the control unit 17 can detect the closed state of the mobile phone 100.

Specifically, for example, the control unit 17 monitors whether or not a detection switch (not shown) of the lower case 102 is pressed by a protrusion portion (not shown) provided on the upper case 101, thereby detecting the closed state (i.e., if the detection switch is pressed, the closed state, otherwise the opened state). In addition, the open and closed detection is not limited to the switch, and various sensors may be used.

FIG. 2 is a block diagram illustrating an interior configuration of an electrical system of the mobile electronic device according to the embodiment of the invention.

As shown in FIG. 2, the mobile phone 100 includes the control unit 17 as a control center, a power control unit 10, a wireless communication unit 11, an operation unit 12, an audio input/output unit 13, a display unit 14, an imaging unit 15, a storage unit 16, and the control unit 17. These components are commonly connected to a system bus 18 formed of a plurality of lines for address, data, and control.

The power control unit 10 includes a power supply unit 31 and a current amplifier 32 as shown in an example of the interior configuration in FIG. 3.

The power supply unit 31 supplies a current obtained through a current monitoring resistor (R) connected to the battery 30 to the blocks constituting the mobile phone 100.

The current amplifier 32 connected to both ends of the current monitoring resistor (R) amplifies a drop in voltage caused by the current monitoring resistor (R), outputs it to an AD converter 180 built in the control unit 17, and the control unit 17 converts it into a current value in order to perform current consumption measurement.

The wireless communication unit 11 catches a wireless communication system, performs wireless communication with a base station (not shown) connected to a communication network, and performs transmission and reception of various kinds of data. The various kinds of data includes audio data at the time of a audio phone call, message data at the time of message transmission and reception, web page data at the time of web browsing, and the like.

The operation unit 12 has keys to which various functions are assigned, for example, a power key, a call key, numeral keys, alphabet keys, direction keys, an enter key, a sending key, function keys, and the like. When the keys are operated by an operator, a signal corresponding to the operation is generated, and the signal is output to the control unit 17 as an instruction of the operator.

The audio input/output unit 13 performs an input/output process of an audio signal output from a speaker or an audio signal input from a microphone.

That is, the input/output unit 13 amplifies the audio signal input from the microphone, performs analog/digital conversion, performs a signal process such as encoding to convert it into digital audio data, and outputs it to the control unit 17.

The input/output unit 13 performs a signal process such as decoding, digital/analog conversion, and amplification, on the audio data supplied from the control unit 17, converts it into an analog audio signal, and output it to the speaker.

The display unit 14 is configured using, for example, an LCD or an OLED, and displays an image according to a video signal supplied from the control unit 17.

The display unit 14 displays, for example, a calling number of a sending destination at the time of wireless transmission by the wireless communication unit 11, a phone number of a transmission source at the time of receiving a phone call, contents of a received message or a transmitted message, date, time, remaining battery amount, completion or not of transmission, a standby screen, and the like.

The imaging unit 15 is camera configured by a photoelectric conversion element such as a CCD (Charge Coupled Device) or CMOS (Complementary Metal Oxide Semiconductor) image sensor, a control circuit thereof and the like.

The storage unit 16 stores various kinds of data used for various processes of the mobile phone 100. For example, computer programs executed by the control unit 17, an address book for managing personal information such as phone numbers of communication targets and e-mail addresses, audio files for playing ringtones and alarm sounds, image files for standby screens, data on various kinds of settings, and temporary data used in a processing course of programs are stored.

Herein, a reference capacity value (reference capacity table 160) consumed within a predetermined time, which is quantitatively calculated on the basis of a current measured in the control unit 17 to be described later, a sleep period current value b (161) measured by a measurement device connected from the outside, and temperature characteristic data 161 and deterioration characteristic data 162 of a battery to be used are stored. Details such as data structure will be described later.

The storage unit 16 is configured by, for example, a non-volatile storage device (non-volatile semiconductor memory, hard disk device, optical disk device, etc.), a random access storage device (e.g., SRAM, DRAM), and the like.

The control unit 17 integrally controls the overall operation of the mobile phone 100.

That is, the control unit 17 controls operations (transmission and reception of signals in the wireless communication unit 11, display of an image in the display unit 14, an imaging process in the imaging unit 15, etc.) of the blocks as various processes (voice phone call performed through a line switching network; writing, transmission, and reception of e-mails; browsing of Web (World Wide Web) sites on the Internet, etc.) of the mobile phone 100 are performed in proper sequence according to operations of the operation unit 12.

The control unit 17 is provided with a computer (microprocessor), which executes processes on the basis of programs (operating system, application program, etc.) stored in the storage unit 16, and performs the processes according to instructed sequence in the programs.

That is, the control unit 17 sequentially reads command codes from the operating system or programs, such as application programs stored in the storage unit 16, and performs the processes.

Herein, the control unit 17 has a sleep mode, and has a function of calculating a remaining battery amount by summing a current value measured at a non-sleep time and an integrating value of a sleep time and a sleep period current value stored in the storage unit 16, and subtracting the sum value from a reference capacity value stored in the storage unit 16.

The control unit 17 has a function of determining whether or not to update the display each time when the remaining battery amount is calculated, and changing the displaying of the remaining battery amount displayed on the display unit 14. The control unit 17 has a function of changing the reference capacity value stored in the storage unit 16 according to a temperature coefficient or a deterioration coefficient of a battery.

The control unit 17 has a function of performing control of the sleep mode at the intermittent reception timing of the wireless communication unit 11, calculating an average value from the sum of the current value measured at the non-sleep time and the integrating value of the sleep time and the sleep period current value stored in the storage unit 16, and displaying the average current value on the display unit 14. Details of the functions of the control unit 17 will be described later.

Recently, the mobile phone 100 stores various kinds of information and adjusted values in a production process. For example, an ammeter (production equipment) used in the production process is used, thereby performing high-precision measurement and accurately measuring a current value in the sleep period of the mobile phone 100.

In the mobile electronic device according to the embodiment of the invention, a current consumption value in the sleep period is measured for each mobile phone 100, and the mobile phone is put on the market after the current consumption value is written in the mobile phone 100 (a predetermined area of the storage unit 16). Accordingly, a very small current value in the sleep period can be accurately stored. In the active period that is the non-sleep period, current consumption is measured in real time by the current monitoring resistor R.

An average value of the current values of the two periods is calculated by using a time ratio, and therefore, it is possible to recognize a more accurate current consumption during the standby mode.

Accordingly, it is possible to perform accurate time estimation of the sleep period, which is difficult in the conventional mobile phone 100, and it is possible to output (display) an accurate remaining battery amount. Therefore, it is possible to display a precise remaining battery amount, like in a video camera or a computer. Hereinafter, details thereof will be described.

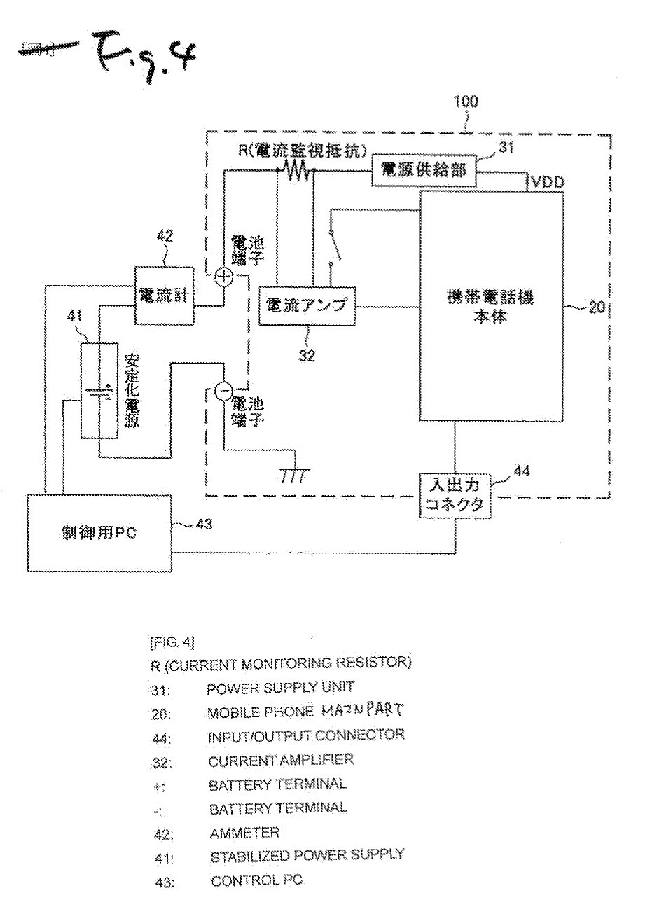

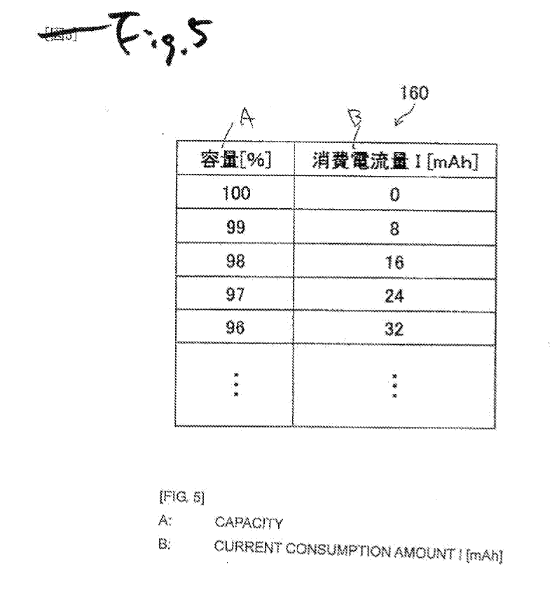

FIG. 4 shows an example of a connection configuration of the mobile phone 100 and the high-precision ammeter used in the production process.

As shown in FIG. 4, in the production process, a stabilized power supply 41 and an ammeter 42 are connected to battery terminals (+ −), instead of the battery 30. To measure a current of 1 mA, recording at least two decimal places is necessary. On the other hand, since an average maximum current of the mobile phone 100 reaches about 1 A (1000 mA), a scale of the storage unit 16 for storing the current requires six digits (0.01 to 1000 mA). That is, hexadecimal 3 bytes are necessary. Herein, when the current in the sleep period is measured in the production process, the ammeter 42 capable of measuring current to 10 μA (0.01 mA) is necessary. Instead of the high-precision ammeter used in the production process, a current is converted into a voltage using a dedicated resistor and then an oscilloscope or a voltmeter may be used.

Then, an instruction of the sleep operation is transmitted to the mobile phone main part 20 (herein, the control unit 17 and the storage unit 16) through the input/output connector 44 by the control PC 43 connected to the ammeter 42.

Accordingly, the control unit 17 of the mobile phone main part 20 enters the sleep operation. At this time, the current value (sleep period current value b) measured by the ammeter 42 is transmitted to the mobile phone main part 20 through the input/output connector 44 (input/output port) by the control PC 43, and can be stored in a predetermined area of the storage unit 16 of the mobile phone main part 20 of the mobile phone 100.

For a battery to be used, the reference capacity table 160 in which a remaining amount (capacity [%]) is associated with a power consumption amount (I [mAh]) is created, and is stored in the storage unit 16, in advance. This is a result of measurement on how much the remaining amount is for each power consumption amount by precisely performing measurement before factory shipment, and is a table used as a reference in a remaining amount determining process thereafter.

FIG. 5 shows an example of a data structure of the reference capacity table 160. The example is a case of a battery with a capacity of 800 mAh at the time of full charge. When the power consumption amount I is 0 mAh, power is not consumed, which is a full-charge state, and thus the remaining amount is 100%. When the power consumption amount is 8 mAh, the remaining amount is 99%. The values shown in FIG. 5 are just an example for simplifying description, and it is obvious that detailed numerical values based on actually measured values correspond to the capacity.

The control unit 17 can specify a remaining amount in comparison to the full charge when the power consumption amount is known by using the reference capacity table 160.

When the current consumption amount I is specified by a process to be described later, the control unit 17 stores only the latest value in an area of the storage unit 16 which is not erased when the power is turned off, and continues updating with the latest information while the power is turned on.

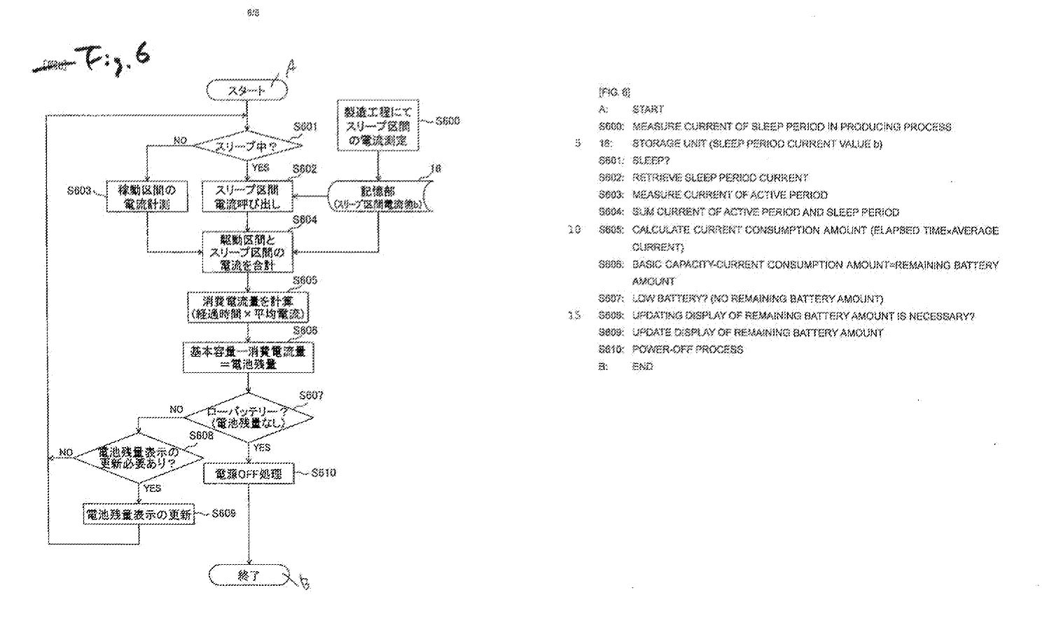

FIG. 6 is a flowchart illustrating an operation of the mobile electronic device according to the embodiment of the invention. Hereinafter, the operation of the mobile electronic device according to the embodiment of the invention shown in FIG. 1 to FIG. 5 will be described in detail with reference to the flowchart shown in FIG. 6.

In the mobile phone 1, the process of the flowchart shown in FIG. 6 is performed in the state where the power is turned on.

The process shown in FIG. 6 is a process repeated after the power is turned on or after it is fully charged and is separated from a charger. Even when the power is turned on again after the power is turned off in a state where it is used to some extent, the same is applied. As described above, “when the power is turned on again after the power is turned off in the state where it is used to some extent”, the current consumption amount I at the time of the previous power off is extracted from the storage unit 16, and it is compared with the reference capacity table 160, thereby specifying a remaining battery amount as a reference.

In the control unit 17, first, it is determined whether or not the mobile phone 100 is in the sleep mode at the standby time (Step S601: sleeping). Herein, when it is determined that it is sleeping (Step S601: Yes), a sleep period current value (b) is retrieved from the storage unit 16 (Step S602). The sleep period current value (b) is measured in the production process as described above, and is stored in a predetermined area of the storage unit 16 in advance (Step S600).

On the other hand, when the mobile phone 100 is active (non-sleep) (Step S601: No), the control unit 17 actually measures the current consumption on the basis of drop in voltage of the current monitoring resistor R in the active period (Step S603).

Subsequently, the control unit 17 calculates a sum of the current value actually measured at the non-sleep time and an integrating value of a sleep time and a sleep period current value stored in the storage unit 16 after the power is turn on (Step S604). An average value may be calculated from the sum value. A current consumption amount after the power is turned on is calculated from the time and the current value (average current) (Step S605).

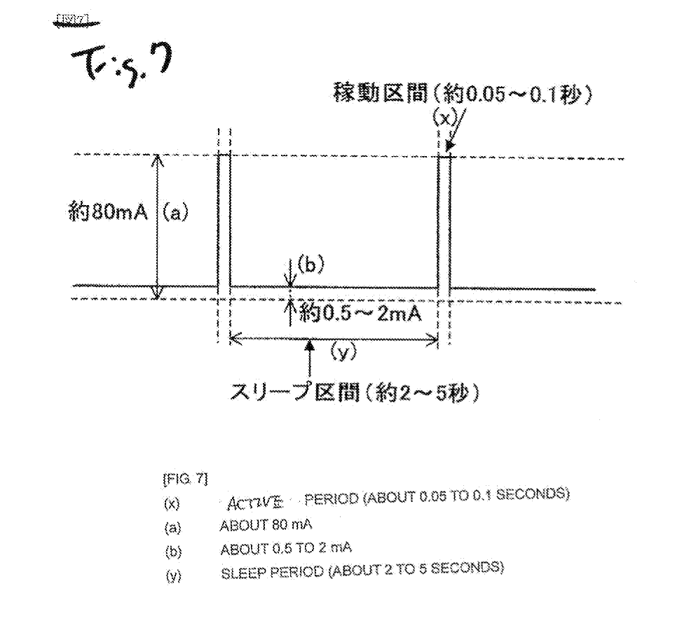

Herein, a specific example of the current consumption amount calculation will be described with reference to FIG. 7. FIG. 7 is a diagram simply illustrating a current wave form (current value) during standby of the mobile phone 100 on a time axis.

In FIG. 7, in the active period x (about 0.05 to 0.1 s), the control unit 17 measures the drop in voltage at both ends of the current monitoring resistor R output from the power control unit 10 at the intermittent reception timing (each several milliseconds) of the wireless communication unit 11, and the control unit 17 calculates current consumption a (about 80 mA) on the basis of the drop in voltage.

In the sleep period y, the control unit 17 operates a counter immediately before changing to the sleep state, and reads the counter immediately after changing to the non-sleep state, thereby calculating a time y (about 2 to 5 s) during the sleep period.

Subsequently, the control unit 17 can acquire current consumption from the time y calculated herein and the sleep period current value b (about 0.5 to 2 mA) stored in a predetermined area of the storage unit 16. The control unit 17 calculates the current consumption amount from the sum of the current consumption values of the active period and the sleep period calculated as described above.

An average current is calculated by averaging the current of the active period and the sleep period. For example, in the current waveform shown in FIG. 7, the average current is obtained from a calculation formula of average current I=(ax+by)/(x+y). In this case, when the active period is 80 mA and 50 ns and the sleep period is 1 mA and 5070 ns, the average current value I is calculated from I=(80×50)/(5070×1)/(50+5070)≈1.77 [mA] on the basis of the calculation formula.

Then, the control unit 17 refers to the reference capacity table 160 stored in a predetermined area of the storage unit 16 on the basis of the current consumption amount 10 when the power is previously turned off, specifies percentage of capacity displayed on the reference capacity table 160, and determines a basic capacity value as a reference. It is noted that in a case immediately after full charging, the reference capacity table 160 is referenced while the previous current consumption amount is set as 0 mAh. The latest remaining battery amount is calculated by subtracting the current consumption In calculated in Step S605 from the determined basic capacity value (Step S606). When the latest remaining battery amount is calculated as described above, the current consumption amount stored in the storage unit 16 is updated by the current consumption amount In at that time.

Here, the control unit 17 changes the values stored in the reference capacity table 160 of the storage unit 16 according to a temperature coefficient and a deterioration coefficient of the used battery 30.

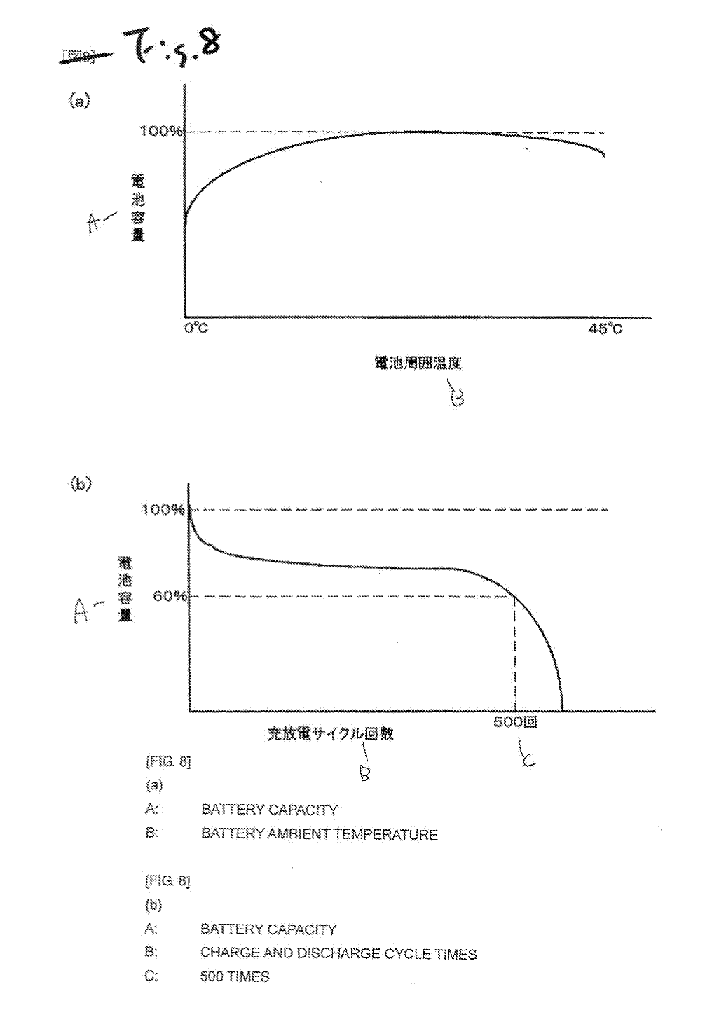

Specific examples of the temperature coefficient and the deterioration coefficient are shown in FIGS. 8(a) and (b), respectively.

FIG. 8(a) is a graph illustrating temperature characteristic data 161, in which a battery capacity is drawn on a vertical axis and a battery ambient temperature is drawn on a horizontal axis for showing a temperature coefficient. The temperature characteristic data 161 is stored in a predetermined area of the storage unit 16. The control unit 17 sets a normal temperature (about 25° C.) as 100%, and changes the basic capacity value using a ratio to a use temperature.

FIG. 8(b) is a graph illustrating deterioration characteristic data, in which a battery capacity is drawn on a vertical axis and a charge/discharge cycle is drawn on a horizontal axis for showing a deterioration coefficient. The deterioration characteristic data 162 is stored in a predetermined area of the storage unit 16. The control unit 17 gradually decreases and changes the basic capacity value due to the number of charge times and time of use (discharge).

A curve of such temperature characteristic data and charge/discharge cycle is stored in the storage unit 16 as a coefficient corresponding to the ambient temperature or the number of charge/discharge times. At the time of performing the process shown in FIG. 6, a coefficient to be multiplied is specified on the basis of the ambient temperature or the number of charge/discharge times, and is used along with the remaining capacity value specified by the power consumption amount Io, thereby calculating a more accurate remaining battery amount by specifying the basic capacity value as a reference.

If the battery 30 is used about 500 times such that the capacity is decreased to 60% and only 60% of capacity can be used until the power is turned off, an alarm may be given in regard to battery life.

The description returns to the flowchart shown in FIG. 6. The control unit 17 calculates the remaining battery amount (Step S606), and then compares the remaining battery amount with a predetermined low battery threshold value to determine whether or not there is a remaining battery amount (Step S607).

The low battery means a remaining amount at which the mobile phone 1 can operate at the minimum. A value of securing power or the like necessary to perform the power-off process such as transfer of information stored in a RAM until that time to a ROM and normal completion of an OS is used as the threshold value.

When it is determined that the remaining battery amount is not the low battery (Step S607: No), the control unit 17 further determines whether or not it is necessary to update a battery pictograph displayed on the display unit 14 as an indication of a remaining battery amount (Step S608). The battery pictograph is a kind of icon displaying indication of a remaining amount by increasing and decreasing the number of bars displayed stepwise according to the remaining battery amount, and different remaining amount threshold values are set for each display stage. The control unit 17 compares the stepwise threshold values with the acquired remaining battery amount. For example, the battery pictograph of three bars has been displayed until that time, but when a remaining amount calculated at this time does not exceed a threshold value of three bars, it has to be updated to two bars. As described above, it is determined whether or not the remaining amount exceeds the threshold value corresponding to the previously specified number of bars of the battery pictograph even in the calculation at this time, thereby determining whether or not to update the display of the battery pictograph. When it is determined that the update of the display is necessary (Step S608: Yes), the control unit 17 changes the display of the remaining battery amount displayed on the display unit 14 (Step S609). When it is determined that the update of the displaying is not necessary (Step S608: No), the control unit 17 returns to the determination process of the operation mode of Step S601.

In the low battery determining process of Step S607, when the remaining battery amount is determined as the low battery (Step S607: Yes), the control unit 17 performs the power-off process (Step S610), and ends the series of processes.

Further, the control unit 17 displays the average value (i.e., average current value during power on) of the current consumption calculated in Step S605 in the flowchart shown in FIG. 6, on the display unit 14.

As described above, according to the mobile electronic device of the embodiment of the invention, in the mobile electronic device having the sleep mode for power saving, the current consumption amount in the sleep period which varies among individual devices is measured in advance and stored in the production process. Accordingly, it is possible to make it easy to measure current in the sleep period without requiring a measurement device with high-resolution precision. Since the current consumption in the sleep period is also affects the management of the remaining battery amount, the remaining amount of the battery 30 can be accurately recognized. Accordingly, for example, when activating an application program such as playing of music and digital broadcasts in the mobile phone 100, the current consumption thereof is measured and it is possible to display the use time from the remaining battery amount.

In the flowchart shown in FIG. 6, in the update determination of the displaying of the remaining battery amount (Step 608), the example of several stage battery pictograph is represented, but it may be more precise. That is, the remaining battery amount may be displayed by percentage with respect to full charge in the digital display. In this case, a remaining battery amount threshold value may be set for each minimum unit on display such as 1% or 0.1%, and it may be determined whether or not the remaining battery amount exceeds the threshold value whenever the period from S601 to S608 shown in FIG. 6 is repeated. When a newly calculated remaining battery amount exceeds the threshold value, the displaying of the minimum unit is updated to a small value, thereby realizing the embodiment.

As described above, according to the embodiment, the remaining battery amount, which is displayed with a large width and can only be used as a rough indication, can be displayed by a value closer to reality.

Since the control unit 17 is configured to display the average value of the current consumption after the power is turned on, on the display unit 14, a user can recognize the use state and can obtain an indication of battery consumption in regard to everyday use. Accordingly, the way of use becomes wider. That is, for example, the battery consumption amount can be reduced to decrease the number of charging.

In addition, since it is possible to monitor the remaining capacity to which the temperature coefficient and the deterioration coefficient of the battery is also reflected, the changed amount from the initial state can be accurately recognized. For example, when the battery life is determined or a sudden change from the previous capacity occurs, recognition of battery change or inducement of repair due to an abnormality in the battery is possible.

The mobile phone 100 is exemplified as the mobile electronic device according to the embodiment of the invention, but the same may be applied to, for example, a PDA (Personal Digital Assistants), electronic schedulers, and game devices having similar configurations.

All the functions of the control unit 17 shown in FIG. 2 may be realized by software, or at least a part thereof may be realized by hardware.

For example, the data process in the control unit 17, which calculates the remaining battery amount by summing the current value measured at the non-sleep time with the integrating value of the sleep time and the sleep period current value stored in the storage unit 16 and subtracting the sum value from the reference capacity value stored in the storage unit 16, may be realized on a computer by one or more programs, and at least a part thereof may be realized by hardware.

The invention has be described in detail or with reference to the specific embodiment, but it is obvious for those who skilled in the art that the invention can be subjected to various modifications and changes which does not deviate from the sprit and scope of the invention.

This application is based on Japanese Patent Application No. 2008-019983, filed on Jan. 30, 2008, the content of which is incorporated herein by reference.

### INDUSTRIAL APPLICABILITY

According to the invention, in the mobile electronic device having the sleep mode for power saving, it is possible to make it easy to measure a current in the sleep period without requiring a measurement device with high-resolution precision.

1. A mobile electronic device comprising:
a battery that is chargeable and dischargeable;
a current measuring unit that measures a current output from the battery;
a control unit that performs an operation control according to either a sleep mode in which an operation restriction is performed for power saving or an active mode in which the operation restriction is not performed; and
a storage unit that stores a current value consumed in a sleep state where the operation control is performed in the sleep mode, as a sleep current value,
wherein the control unit acquires a present remaining battery amount by summing a current consumption amount, which is a current amount consumed in an active state where the operation control is performed in the active mode and calculated on the basis of a current value measured by the current measuring unit, and an integrating value of an operation time in the sleep state and the sleep current value, and subtracting the sum value from a predetermined reference capacity value of the battery.

2. The mobile electronic device according to claim 1,
wherein the storage unit stores a table in which a capacity value of the battery is associated with each current consumption amount, in advance, and
wherein the control unit uses, as the predetermined reference capacity value, a capacity value which is specified by referring to the table with a sum value at a previous calculating time as the current consumption amount.

3. The mobile electronic device according to claim 1, further comprising:
a display unit that performs display regarding the remaining battery amount,
wherein the control unit compares the acquired remaining battery amount with a plurality of predetermined stepwise threshold values each time when the remaining battery amount is calculated, and updates the display regarding the remaining battery amount when the remaining battery amount exceeds each of the plurality of threshold values.

4. The mobile electronic device according to claim 1,
wherein the control unit changes the predetermined reference capacity value stored in the storage unit according to a temperature coefficient or a deterioration coefficient of the battery.

5. The mobile electronic device according to claim 1, further comprising:
a wireless communication unit,
wherein the control unit performs operation control of the sleep mode at least at an intermittent reception timing of the wireless communication unit.

6. The mobile electronic device according to claim 3,
wherein the control unit calculates an average current value from the sum of the current value measured by the current measuring unit in the active mode and the integrating value of the operation time in the sleep state and the sleep current value stored in the storage unit, and displays the average current value on the display unit.
